(19) United States
(12) Patent Application Publication
(10) Pub. No.: US 2019/0138354 A1
(43) Pub. Date: May 9, 2019

(54) METHOD FOR SCHEDULING JOBS WITH IDLE RESOURCES

(71) Applicant: NATIONAL APPLIED RESEARCH LABORATORIES, Hsinchu City (TW)

(72) Inventors: CHIA-CHEN KUO, HSINCHU CITY (TW); I-CHEN WU, HSINCHU CITY (TW); LUNG-PIN CHEN, TAICHUNG CITY (TW); CHUAN-LIN LAI, HSINCHU CITY (TW); YEN-LING CHANG, KEELUNG CITY (TW); CHENG-LUN TSAI, NEW TAIPEI CITY (TW); CHIANG-HSIANG LIEN, HSINCHU CITY (TW)

(21) Appl. No.: 16/180,379

(22) Filed: Nov. 5, 2018

(30) Foreign Application Priority Data
Nov. 9, 2017 (TW) 106138783

(51) Int. Cl. G06F 9/48; G06F 9/50

(52) U.S. Cl. CPC G06F 9/4887; G06F 9/5027

(57) ABSTRACT

The present invention provides a method for scheduling jobs with idle resources. When the computational units of computers are idle, according to the variation of idle time, appropriate jobs may be allocated to the computational units. Then the unscheduled jobs may be completed by using idle time segments. Thereby, the utilization rate of computation resources and the completion rate of jobs may be enhanced.

### FIELD OF THE INVENTION

The present invention relates generally to a method for scheduling jobs, and particularly to a method for scheduling jobs with idle resources.

### BACKGROUND OF THE INVENTION

The process of generating images on computers is called rendering. There is another description for rendering: Rendering is the process of calculating the effects in video files for outputting the final video. This process usually requires large-scale computations and may be applied to games, simulations, movies, and animation movies. Besides, these applications also require time constraint. In addition to targeting on completing calculations in the shortest time, the completion time needs to be controlled accurately. Accordingly, render farms are developed to meet the requirements.

A render farm is a computer suitable for executing massive computation tasks. Practically, it may be a cluster computer system formed by connecting thousands or tens of thousands of servers through networks. Each server owns its own memories and storage devices, as well as shared memories and storage devices. In addition, the servers may be general computers or computers specifically for processing images.

Because the computation resources are huge, a render farm can satisfy the jobs requiring massive computations. Nonetheless, it faces problems of resource management and maintenance. The resource management involves how to allocate appropriate computation resources to jobs requiring them. Jobs may be classified into rigid jobs, moldable jobs, and adaptive jobs. Rigid jobs require a fixed number of processor for operations. Moldable jobs can change the number of processors at job start but does not allow redeploy during execution. For adaptive jobs, the number of processors may be changed during execution. Adaptive jobs may be further classified into the following two types: evolving jobs and malleable jobs. For evolving jobs, the number of processors may be changed by application programs. For malleable jobs. The number of processors may be changed by external job schedulers.

In general, the jobs in job schedulers are rigid and moldable jobs. For these two types of jobs, once the computation resources are not evenly allocated, the utilization rate of computation resources will be insufficient, for example, when a job is completed but the next scheduled job has insufficient computation resources for execution, or when a job cannot go on without other resources or computation results. Consequently, waiting is unavoidable, which leads to processor idling. In this period, idle processors will not execute any job, resulting in waste of computation resources and low completion rate of jobs. In addition, excessively frequent usage of equipment might lead to wear problems.

In current technologies, the temperature of operating equipment may be measured for understanding the utilization frequency of equipment and then allocating subsequent tasks. Alternatively, monitoring devices may be disposed for understanding the operating status of computation resources and then adjusting the tasks executed by the resources. Or, the allocation of computation resources may be determined according to the emphases of different tasks for achieving the purpose of maximizing resource efficiency.

Unfortunately, these technologies do not mention how to maximize the utilization of idle processors. As described above, malleable jobs can change the number of processors using job schedulers. This type of jobs may be executed by utilizing idle processors without delaying normal operational jobs. Once the jobs allocated to the idle time may be finished, the utilization rate and completion rate of computation resources will be enhanced significantly.

As mentioned above, when computation resources process various jobs, sometimes, due to resource allocation or interdependence among jobs, the subsequent jobs cannot be executed until the previous one is finished, leading to processor idling and waste of resources. Thereby, artificial monitoring is most adopted currently. When computation resources are idle, appropriate jobs are allocated manually. Then the waste of computation resources may be avoided if idle time segments are utilized for processing.

Nonetheless, artificial monitoring of computation resource system and job allocation cannot maximize the utilization of resources. It is true that when idle computation resources are found manually, jobs may be allocated to the idle processors. Unfortunately, it is uneasy to assess if the idle time is sufficient to finish the allocated job. Once the job is not finished, it must be returned to the computation resources. This job is deemed fail and recalculation is required. In addition, because the executing jobs of computation resources are distributed in respective computers, it is difficult to manually collect and handle the usage statuses of these processors. Consequently, monitoring and managing processors is an extremely time-consuming task.

Accordingly, the present invention provides a solution to solve the problem described above. According to the rendering history, the time pattern of idle resources may be deduced. Once the idle resource is short, the job requiring short execution time is allocated. If the idle resource is longer, the job requiring longer execution time may be arranged. BY using this method, the completion rate of jobs may be improved.

The present invention provides a method for scheduling jobs with idle resources. According to the variation of idle time, appropriate jobs may be allocated to processors. The unscheduled jobs may be completed by using idle time segments. Thereby, the utilization rate of computation resources and the completion rate of jobs may be enhanced.

### SUMMARY

An objective of the present invention is to provide a method for scheduling jobs with idle resources. When computation resources are idle, computation tasks are allocated to the idle computation resources for improving their utilization rate.

Another objective of the present invention is to provide a method for scheduling jobs with idle resources. It is a method for allocating computation resources. According to the idle time of the idle computation resources, the idle computation resources are allocated to computation tasks requiring different time to complete. Thereby, the completion rate of tasks may be increased.

A further objective of the present invention is to provide a method for scheduling jobs with idle resources. It is a method for allocating computation resources dynamically. The allocated tasks may be changed by adjusting the threshold value dynamically according to the idle time of computation resources and the remaining tasks so that the tasks requiring different execution time are completed almost concurrently. Thereby, the situation of remaining the tasks requiring massive execution time after the tasks requiring short execution time are completed may be avoided.

In order to achieve the above objectives, according to an embodiment of the present invention, a method for scheduling jobs with idle resources is disclosed, comprising steps of: a scheduler allocating one of a plurality of first jobs to a processor when the processor is idle, and the execution times of the plurality of first jobs corresponding to a plurality of first execution times and a plurality of second execution times; a timer counting an idle time by accumulating one of the plurality of first execution times or one of the plurality of second execution times; the scheduler allocating one of the plurality of first jobs to the processor when the idle time is smaller than a first threshold value and one of the plurality of second jobs to the processor when the idle time is greater than the first threshold value.

According to an embodiment of the present invention, the plurality of first execution times may be identical to the plurality of second execution times.

According to an embodiment of the present invention, the execution times of the plurality of second jobs correspond to a plurality of third execution times and a plurality of fourth execution times.

According to an embodiment of the present invention, the plurality of third execution times may be identical to the plurality of fourth execution times.

According to an embodiment of the present invention, in the step of when the idle time is smaller than the first threshold value, the first threshold value is lowered to a second threshold value when the coefficient of the consumption rate of the plurality of second jobs versus the average consumption rate of the plurality of first jobs and the plurality of second jobs is negative.

According to an embodiment of the present invention, in the step of when the idle time is greater than the first threshold value, the first threshold value is raised to a third threshold value when the coefficient of the consumption rate of the plurality of second jobs versus the average consumption rate of the plurality of first jobs and the plurality of second jobs is positive.

According to an embodiment of the present invention, the method for calculating the second threshold value or the third threshold value comprises the following steps of: calculating an average consumption rate, which is the ratio of the sum of the number of the plurality of completed first jobs and the plurality of completed second jobs to the sum of the number of the plurality of first jobs and the plurality of second jobs; calculating a logarithm value, which is the logarithm of the ratio of a consumption rate of the plurality of second jobs to the average consumption rate; calculating a floating value, which is one of the plurality of third execution times of the plurality of second jobs multiplied by the logarithm value and a displacement value or one of the plurality of fourth execution times of the plurality of second jobs multiplied by the logarithm value and the displacement value; and adding the floating value to the first threshold value.

According to an embodiment of the present invention, the displacement value is used for adjusting the variation rate of the second threshold value or the third threshold value.

In order to achieve the above objectives, according to an embodiment of the present invention, a method for scheduling jobs with idle resources is disclosed, comprising steps of: a timer counting a first idle time when a processor is idle; a scheduler allocating one of a plurality of first jobs to the processor when the first idle time is smaller than a first threshold value, and the execution times of the plurality of first jobs corresponding to a plurality of first execution times and a plurality of second execution times, or the scheduler allocating one of a plurality of second jobs to the processor when the first idle time is greater than the first threshold value, and the execution times of the plurality of second jobs corresponding to a plurality of third execution times and a plurality of fourth execution times; the timer counting a second idle time, which is the sum of the first idle time and one of the plurality of first execution times, the sum of the first idle time and one of the plurality of second execution times, the sum of the first idle time and one of the plurality of third execution times, or the sum of the first idle time and one of the plurality of fourth execution times; and the scheduler allocating one of the plurality of first jobs to the processor when the second idle time is smaller than the first threshold value and one of the plurality of second jobs to the processor when the second idle time is greater than the first threshold value.

According to an embodiment of the present invention, the plurality of first execution times may be identical to the plurality of second execution times.

According to an embodiment of the present invention, the plurality of third execution times may be identical to the plurality of fourth execution times.

According to an embodiment of the present invention, in the step of when the second idle time is smaller than the first threshold value, the first threshold value is lowered to a second threshold value when the coefficient of the consumption rate of the plurality of second jobs versus the average consumption rate of the plurality of first jobs and the plurality of second jobs is negative.

According to an embodiment of the present invention, the first threshold value is raised to a third threshold value when the coefficient of the consumption rate of the plurality of second jobs versus the average consumption rate of the plurality of first jobs and the plurality of second jobs is positive.

According to an embodiment of the present invention, the method for calculating the second threshold value or the third threshold value comprises the following steps of: calculating an average consumption rate, which is the ratio of the sum of the number of the plurality of completed first jobs and the plurality of completed second jobs to the sum of the number of the plurality of first jobs and the plurality of second jobs; calculating a logarithm value, which is the logarithm of the ratio of a consumption rate of the plurality of second jobs to the average consumption rate; calculating a floating value, which is one of the plurality of third execution times of the plurality of second jobs multiplied by the logarithm value and a displacement value or one of the plurality of fourth execution times of the plurality of second jobs multiplied by the logarithm value and the displacement value; and adding the floating value to the first threshold value.

According to an embodiment of the present invention, the displacement value is used for adjusting the variation rate of the second threshold value or the third threshold value.

In order to achieve the above objectives, according to another embodiment of the present invention, a method for scheduling jobs with idle resources is disclosed, comprising steps of: a scheduler allocating a first job to a processor when the processor is idle, and the execution time of the first job corresponding to a first execution time; a timer counting an idle time by accumulating the first execution time; the scheduler allocating a second job to the processor when the idle time is smaller than a threshold value and a third job to the processor when the idle time is greater than the threshold value.

According to an embodiment of the present invention, the execution time of the second job is a second execution time.

According to an embodiment of the present invention, the second execution time may be identical to the first execution time.

According to an embodiment of the present invention, the execution time of the third job is a third execution time.

In order to achieve the above objectives, according to an embodiment of the present invention, a method for scheduling jobs with idle resources is disclosed, comprising steps of: a timer counting a first idle time when a processor is idle; a scheduler allocating a first job to the processor when the first idle time is smaller than a threshold value, and the execution time of the first job corresponding to a first execution time, or the scheduler allocating a second job to the processor when the first idle time is greater than the threshold value, and the execution time of the second job corresponding to a second execution time; the timer counting a second idle time, which is the sum of the first idle time and the first execution time or the sum of the first idle time and the second execution time; and the scheduler allocating a third job to the processor when the second idle time is smaller than the threshold value and a fourth job to the processor when the second idle time is greater than the threshold value.

According to an embodiment of the present invention, the execution time of the third job is a third execution time.

According to an embodiment of the present invention, the third execution time may be identical to the first execution time.

According to an embodiment of the present invention, the execution time of the fourth job is a fourth execution time.

According to an embodiment of the present invention, the fourth execution time may be identical to the second execution time.

In order to achieve the above objectives, according to another embodiment of the present invention, a method for scheduling jobs with idle resources is disclosed, comprising steps of: a scheduler allocating a first job to a processor when the processor is idle, and the execution time of the first job being a first execution time; the scheduler allocating a second job to the processor, and the execution time of the second job being a second execution time; and the first execution time is shorter than the second execution time.

### BRIEF DESCRIPTION OF THE DRAWINGS

FIG. 1 shows a flowchart of the method for scheduling jobs with idle resources according a first embodiment of the present invention;

FIG. 2 shows a schematic diagram of the system for the method for scheduling jobs with idle resources according a first embodiment of the present invention;

FIG. 3 shows a flowchart of the method for scheduling jobs with idle resources according a second embodiment of the present invention;

FIG. 4 shows a flowchart of the method for scheduling jobs with idle resources according a third embodiment of the present invention;

FIG. 5 shows a flowchart of the method for scheduling jobs with idle resources according a fourth embodiment of the present invention;

FIG. 6 shows a flowchart of the method for scheduling jobs with idle resources according a fifth embodiment of the present invention;

FIG. 7 shows a flowchart of the method for scheduling jobs with idle resources according a sixth embodiment of the present invention; and

FIG. 8 shows a flowchart of the method for scheduling jobs with idle resources according a seventh embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present embodiment provides a method for scheduling jobs with idle resources. In the past, when processors are idle, the artificial monitoring method is adopted for allocating appropriate jobs to the idle processors for increasing their utilization rate. Unfortunately, it is difficult for artificial allocation to assess the length of the idle time of the idle processors. Thereby, it is uneasy to allocate jobs to the processors accurately. Once the processors should be returned, the executing jobs will be unfinished and failed. Next time, the jobs should be recalculated. Although the utilization rate seems to be raised, the completion rate is not.

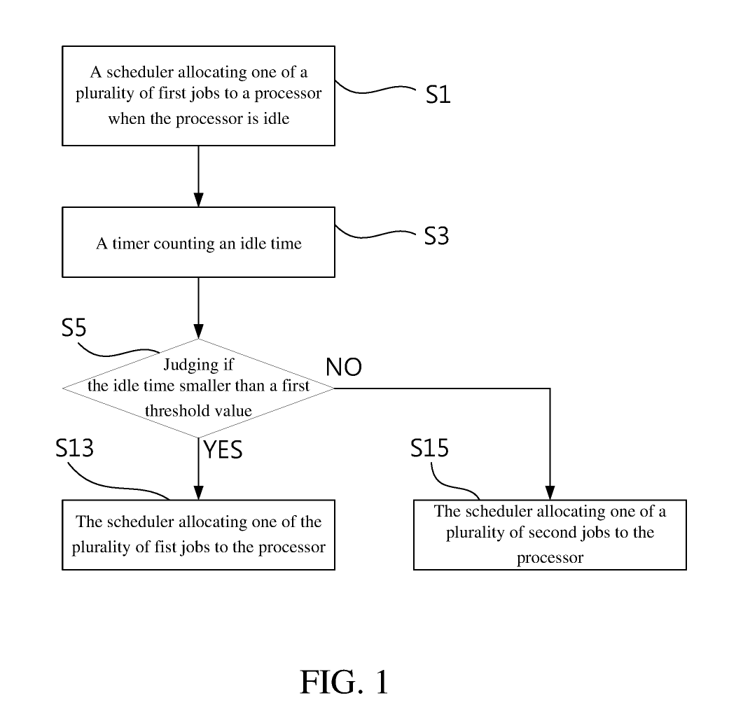

In the following, the method for scheduling jobs with idle resources according to the first embodiment of the present invention will be described. Please refer to FIG. 1, which shows a flowchart of the method for scheduling jobs with idle resources according a first embodiment of the present invention, comprising steps of:

Step S1: A scheduler allocating one of a plurality of first jobs to a processor when the processor is idle;
Step S3: A timer counting an idle time;
Step S5: Judging if the idle time smaller than a first threshold value;
Step S13: The scheduler allocating one of the plurality of first jobs to the processor; and
Step S15: The scheduler allocating one of a plurality of second jobs to the processor.

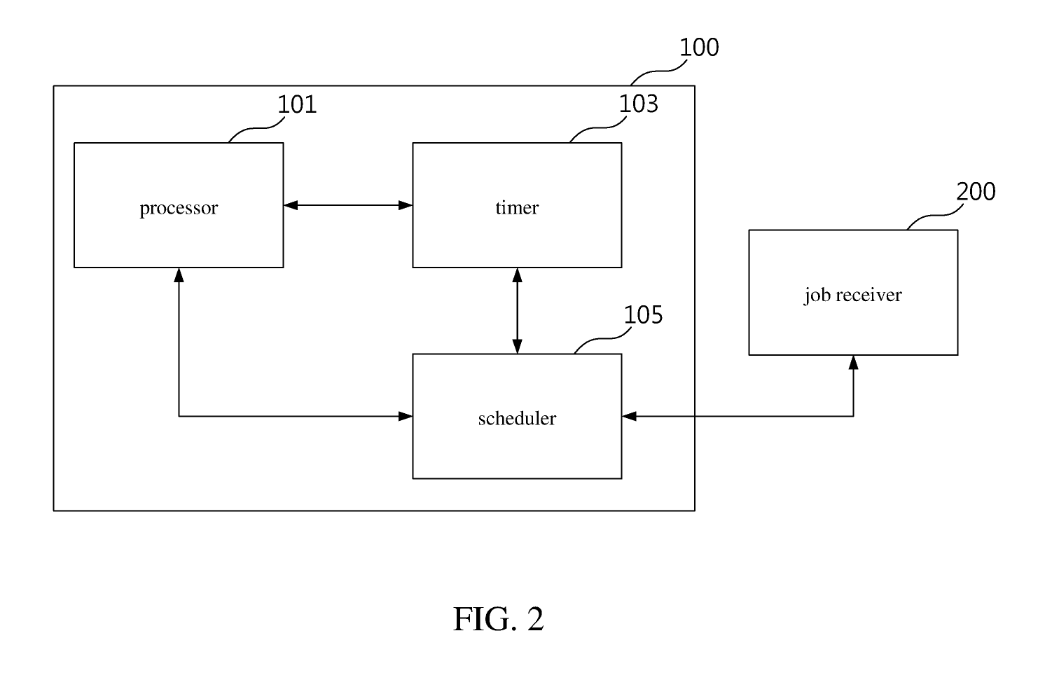

Next, the system required to achieve the method for scheduling jobs with idle resources according to the first embodiment of the present invention will be described. Please refer to FIG. 2, which shows a schematic diagram of the system for the method for scheduling jobs with idle resources according a first embodiment of the present invention. As shown in the figure, the system comprises a render system 100 and a job receiver 200. The render system 100 includes a processor 101, a timer 103, and a scheduler 105 connected electrically to one another. In addition, the scheduler 105 is connected electrically to the job receiver 200. When the processor is idle, the scheduler allocates an appropriate job from the job receiver 200 to the processor 101, and the timer 103 will count the length the processor is idle.

In the following the flow for the method for scheduling jobs with idle resources according to the first embodiment of the present invention will be described. Please refer to FIGS. 1 and 2. The job receiver 200 includes two types of jobs, including the first jobs and the second jobs. The execution times for the first jobs are either first execution times or second execution times; and the execution times for the second jobs are either third execution times or fourth execution times. After the process 101 in the render system 100 executes general jobs, the steps S1 through S9 are executed.

In the step S1, the processor 101 is idle. Then the scheduler 105 allocates a first job form the job receiver 200 to the processor 101 for execution. In the step S3, the timer 103 will count the length the processor 101 is idle. Because the scheduler 105 will allocate jobs to the processor 101 as soon as the processor 101 is idle, the current idle time is equal to the time the processor 101 processes the first job. In the step S3, as the scheduler 105 detects that the idle time is smaller than the first threshold value, it allocates the job having any execution time in the first jobs to the processor 101 for execution. In the step S15, if the idle time is greater than the first threshold value, the scheduler 105 allocate the having any execution time in the second jobs to the processor 101 for execution.

Then, the method for scheduling jobs with idle resources according to the first embodiment of the present invention is completed. By using idle processors and the timer and according to the length of the idle time of the processors, jobs with different execution times are distributed for increasing the utilization rate of computation resources.

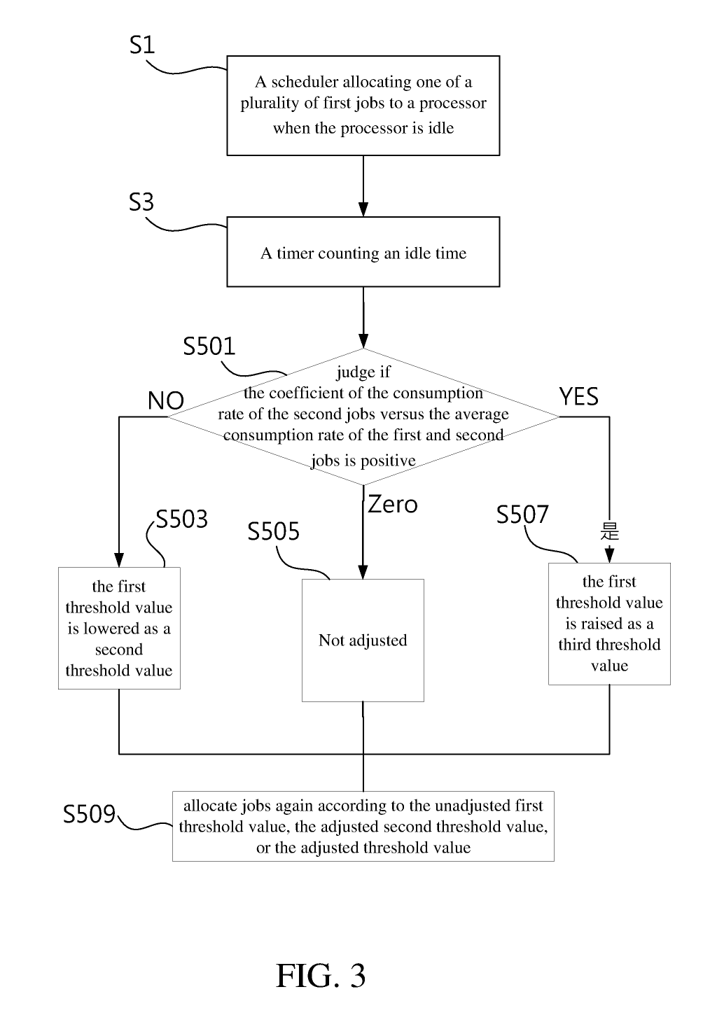

Next, the method for scheduling jobs with idle resources according to a second embodiment of the present invention will be described. Please refer to FIG. 3, which shows a flowchart of the method for scheduling jobs with idle resources according a second embodiment of the present invention. The difference between the flow according to the present embodiment and the one according to the previous one is that the step S5 according to the first embodiment of the present invention is extended to steps S501 to S509 in the flow according to the present embodiment.

In the step S501, in the job receiver 200, judge if the coefficient of the consumption rate of the second jobs versus the average consumption rate of the first and second jobs is positive. If so, the step S503 is executed. If the coefficient is negative, the step S507 is executed. To zero, go to the step S505.

In the step S503, the first threshold value is lowered as a second threshold value.

In the step S505, because the consumption is stable, threshold value will not be adjusted.

In the step S507, the first threshold value is raised as a third threshold value.

In the step S509, allocate jobs again according to the unadjusted first threshold value, the adjusted second threshold value, or the adjusted threshold value for executing the calculation and comparison steps S1 to S5 and the step S13.

In the above embodiments, the first and second jobs are taken as an example. Thereby, the adjustment of the first threshold value is judged according to the consumption of jobs compared with the consumption of all jobs after the first threshold value is adopted as the reference. In more embodiments for jobs, a job consumption rate is calculated by dividing the number of all job consumption after adopting a threshold value as the reference by the number of all job consumption. By taking the logarithm of the job consumption rate versus the average job consumption, the coefficient is calculated. According to the coefficient, whether the threshold value should be adjusted may be judged.

In addition, in the steps S503, S505, S507, the step of calculating an average consumption rate is executed first for dividing the sum of the number of the plurality of completed first jobs and the number of the plurality of completed second jobs by the sum of the number of the plurality of first jobs and the number of the plurality of second jobs. Next, calculate a logarithm value of a consumption rate of the plurality of second jobs divided by the average consumption rate. Then, calculate a floating value, which is one of the plurality of third execution times of the plurality of second jobs multiplied by the logarithm value and a displacement value or one of the plurality of fourth execution times of the plurality of second jobs multiplied by the logarithm value and the displacement value. Finally, add the floating value to the first threshold vale for executing the lowering, unchanging, and raising steps corresponding to the steps S503, S505, and S507.

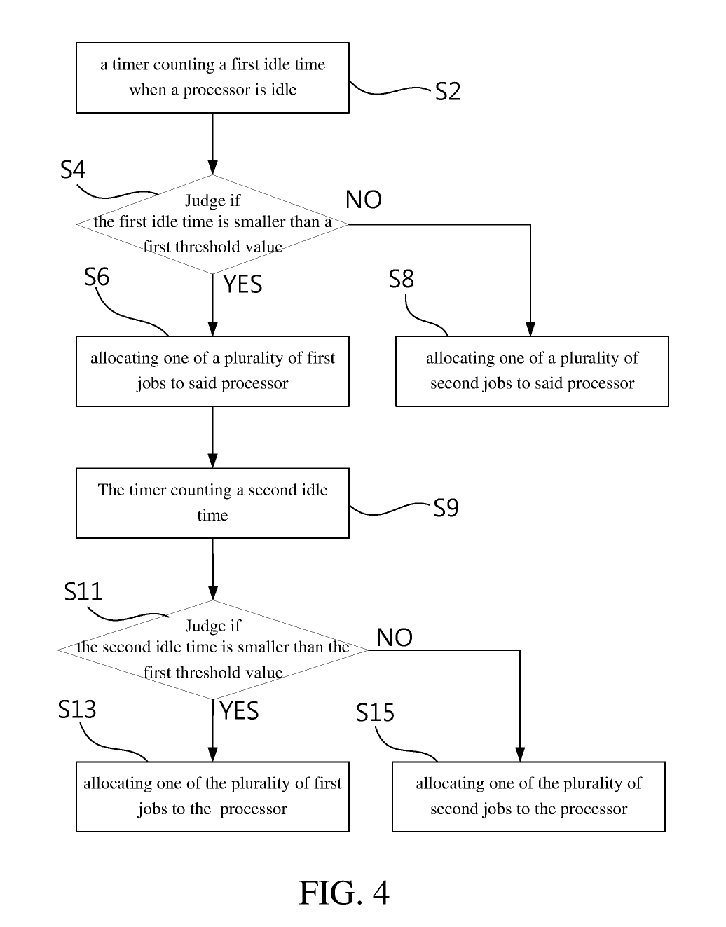

Next, the method for scheduling jobs with idle resources according to a third embodiment of the present invention will be described. Please refer to FIG. 4, which shows a flowchart of the method for scheduling jobs with idle resources according a third embodiment of the present invention. The differences between the flow according to the present embodiment and the one according to the first embodiment are that according to the present embodiment, steps S2, S4, S9, S11 are added; the steps S1, S3, S5 are removed; the step S6 replaces the step S13; and the step S8 replaces the step S15.

The difference between the present embodiment and the first embodiment according to the present invention is that according to the present embodiment, when the processor 101 is idle, the timer 103 is used for counting its idle time and determining whether the first or second jobs is allocated according to the length of the idle time, instead of allocating the first job directly to the processor 101 at the beginning. This means that the processor 101 might not be in the idle state right after a complete job; it might have been in the idle state for a period since no job is allocated to it.

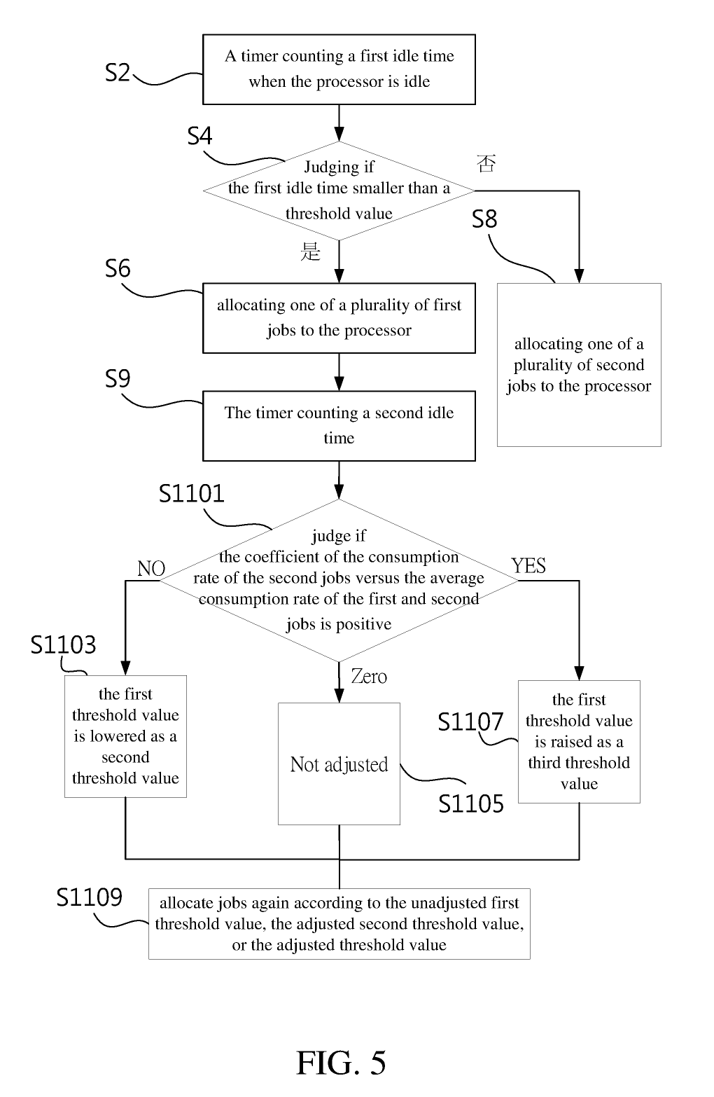

Next, the method for scheduling jobs with idle resources according to a fourth embodiment of the present invention will be described. Please refer to FIG. 5, which shows a flowchart of the method for scheduling jobs with idle resources according a fourth embodiment of the present invention. The difference between the flow according to the present embodiment and the third embodiment according to the present invention is that the step S11 according to the third embodiment of the present invention is extended to the steps S1101 to S1109, which are the same as the steps S501 to S509 according to the second embodiment of the present invention. Hence, the details will not be described again.

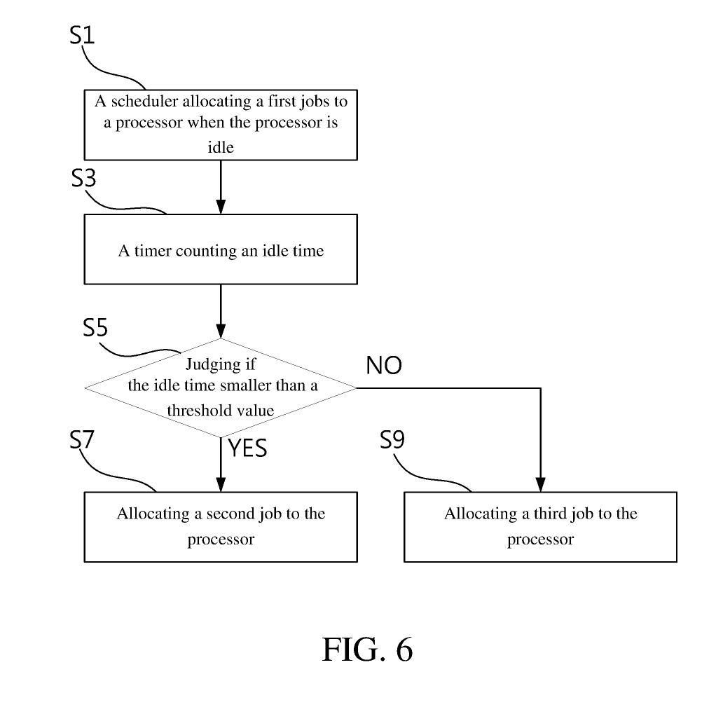

Next, the method for scheduling jobs with idle resources according to a fifth embodiment of the present invention will be described. Please refer to FIG. 6, which shows a flowchart of the method for scheduling jobs with idle resources according a fifth embodiment of the present invention, comprising steps of:

Step S1: A scheduler allocating a first jobs to a processor when the processor is idle;

Step S3: A timer counting an idle time;

Step S5: Judging if the idle time smaller than a threshold value;

Step S7: Allocating a second job to the processor; and

Step S9: Allocating a third job to the processor.

The difference between the present embodiment and the second one is that according to the present embodiment, the threshold value will not be changed due to the variation in job number and types. In other words, the threshold value is fixed.

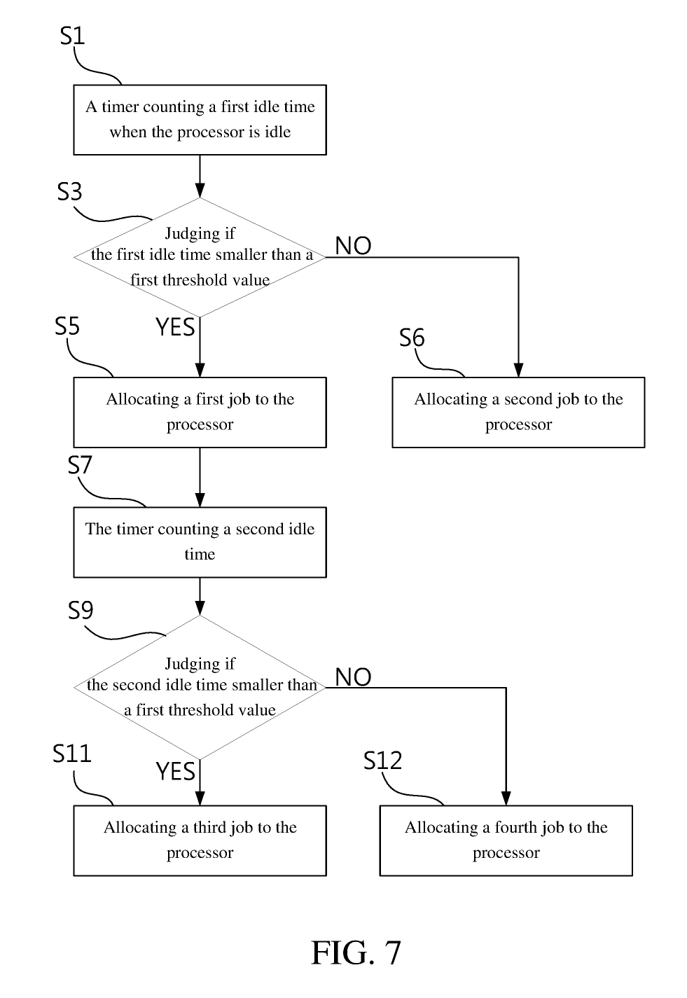

Next, the method for scheduling jobs with idle resources according to a sixth embodiment of the present invention will be described. Please refer to FIG. 7, which shows a flowchart of the method for scheduling jobs with idle resources according a sixth embodiment of the present invention, comprising steps of:

Step S1: A timer counting a first idle time when the processor is idle;

Step S3: Judging if the first idle time smaller than a first threshold value;

Step S5: Allocating a first job to the processor;

Step S6: Allocating a second job to the processor;

Step S7: The timer counting a second idle time;

Step S9: Judging if the second idle time smaller than the threshold value;

Step S11: Allocating a third job to the processor; and

Step S12: Allocating a fourth job to the processor.

In the following, the method for scheduling jobs with idle resources according to a sixth embodiment of the present invention will be described. Please refer to FIGS. 2 and 7. According to the length of the idle time of the processor, the idle time is divided to have three threshold values: T₁: 0˜500 s, T₂: 500˜1000 s, T₃: 1000˜2000 s. There are four jobs: the execution time for W₁ is 200 s; the execution time for W₂ is 400 s; the execution time for W₃ is 600 s; and the execution time for W₄ is 1200 s. Besides, before the processor executes the next job, the idle time is 1500 s.

Please refer to the step S1. When the processor 101 finishes a job and before starting the next one, it is in an idle state. A timer 103 is used for recording the length of the idle time of the processor 101. At first, the idle time of the processor 101 is smaller than the threshold value T₁, thereby the scheduler 105 allocates a short-time job to the processor 101. In other words, the scheduler 105 allocates W₁ to the processor 101 for execution.

Next, after the processor finishes W₁ and in the idle state, the idle time counted by the timer 103 is 200 s, not exceeding the threshold value T₁. Thereby, the scheduler 105 continues to allocate a short-time job to the processor 101. In other words, the scheduler 105 allocates W₂ to the processor 101 for execution.

Next, please refer to the step S3. When the processor 101 finishes W₂, the idle time counted by the timer 103 is 600 s, exceeding the threshold value T₁ but lower than the threshold value T₂. In addition, the processor 101 is still in the idle state. Thereby, the scheduler 105 allocates a middle-time job to the processor 101. In other words, the scheduler 105 allocates W₃ to the processor 101 for execution.

Next, please refer to the step S3. When the processor 101 finishes W₃, the idle time counted by the timer 103 is 1200 s, exceeding the threshold value T₂ but lower than the threshold value T₃. In addition, the processor 101 is still in the idle state. Thereby, the scheduler 105 allocates a long-time job to the processor 101. In other words, the scheduler 105 allocates W₄ to the processor 101 for execution.

Next, when the processor 101 is executing W₄, the processor 101 needs to execute the original job at 1500 s. Thereby, W₄ is interrupted. At this moment, W₄ is not finished yet. If a job is interrupted during execution, the job will be kept in the job receiver 200. As the condition is suitable, the scheduler 105 still will allocate the job to the idle processor 101.

Accordingly, the flow of the method for scheduling jobs with idle resources according to a sixth embodiment of the present invention during practical application is completed. According to the length of the idle time of the processor 101, jobs with different execution times will be allocated. Starting from the jobs requiring shorter execution times, as the idle time becomes longer, the jobs requiring more execution times will be allocated. Thereby, the utilization rate of computation resources and the completion rate of jobs may be enhanced. The embodiment is only an example of practical usage, not used for limiting the present invention. Those variations having concepts or flows identical or similar to the present invention are regarded in the scope of the present invention.

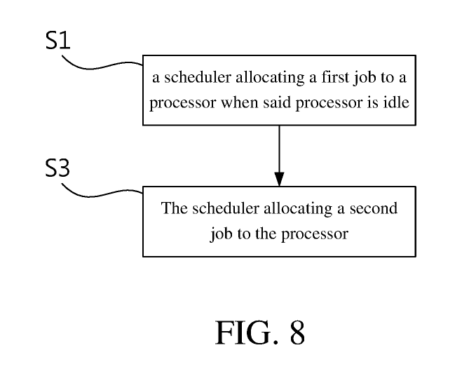

Next, the method for scheduling jobs with idle resources according to a seventh embodiment of the present invention will be described. Please refer to FIG. 8, which shows a flowchart of the method for scheduling jobs with idle resources according a seventh embodiment of the present invention, comprising steps of:

Step S1: A scheduler allocating a first job to a processor when the processor is idle; and

Step S3: The scheduler allocating a second job to the processor.

The difference between the seventh embodiment and the previous embodiments is that as soon as the processor is idle, the execution time of the job as allocated by the scheduler will be longer than the execution time of the job allocated in the last time.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A method for scheduling jobs with idle resources, comprising steps of:
a scheduler allocating one of a plurality of first jobs to a processor when said processor is idle, and the execution times of said plurality of first jobs corresponding to a plurality of first execution times and a plurality of second execution times;
a timer counting an idle time by accumulating one of said plurality of first execution times or one of said plurality of second execution times;
said scheduler allocating one of said plurality of first jobs to said processor when said idle time is smaller than a first threshold value, and allocating one of said plurality of second jobs to said processor when said idle time is greater than said first threshold value.

2. The method for scheduling jobs with idle resources of claim 1, wherein said plurality of first execution times may be identical to said plurality of second execution times.

3. The method for scheduling jobs with idle resources of claim 1, wherein said execution times of said plurality of second jobs correspond to a plurality of third execution times and a plurality of fourth execution times.

4. The method for scheduling jobs with idle resources of claim 3, wherein said plurality of third execution times may be identical to said plurality of fourth execution times.

5. The method for scheduling jobs with idle resources of claim 1, wherein in said step of when said idle time is smaller than said first threshold value, said first threshold value is lowered as a second threshold value when the coefficient of the consumption rate of said plurality of second jobs versus said average consumption rate of said plurality of first jobs and said plurality of second jobs is negative.

6. The method for scheduling jobs with idle resources of claim 5, wherein the method for calculating said second threshold value or said third threshold value comprises the following steps of:
calculating said average consumption rate and the consumption rate of said plurality of second jobs;
calculating a logarithm value corresponding to said average consumption rate and said consumption rate of said plurality of second jobs;
calculating a floating value, which is one of said plurality of third execution times of said plurality of second jobs multiplied by said logarithm value and a displacement value or one of said plurality of fourth execution times of said plurality of second jobs multiplied by said logarithm value and said displacement value; and
adding said floating value to said first threshold value.

7. The method for scheduling jobs with idle resources of claim 6, wherein said displacement value is used for adjusting the variation rate of said second threshold value or said third threshold value.

8. The method for scheduling jobs with idle resources of claim 1, wherein in said step of when said idle time is greater than said first threshold value, said first threshold value is raised as a third threshold value when the coefficient of the consumption rate of said plurality of second jobs versus said average consumption rate of said plurality of first jobs and said plurality of second jobs is positive.

9. The method for scheduling jobs with idle resources of claim 8, wherein the method for calculating said second threshold value or said third threshold value comprises the following steps of:
calculating said average consumption rate and the consumption rate of said plurality of second jobs;
calculating a logarithm value corresponding to said average consumption rate and said consumption rate of said plurality of second jobs;
calculating a floating value, which is one of said plurality of third execution times of said plurality of second jobs multiplied by said logarithm value and a displacement value or one of said plurality of fourth execution times of said plurality of second jobs multiplied by said logarithm value and said displacement value; and
adding said floating value to said first threshold value.

10. The method for scheduling jobs with idle resources of claim 9, wherein said displacement value is used for adjusting the variation rate of said second threshold value or said third threshold value.

11. A method for scheduling jobs with idle resources, comprising steps of:
a timer counting a first idle time when a processor is idle;
a scheduler allocating one of a plurality of first jobs to said processor when said first idle time is smaller than a first threshold value, and the execution times of said plurality of first jobs corresponding to a plurality of first execution times and a plurality of second execution times, or said scheduler allocating one of a plurality of second jobs to said processor when said first idle time is greater than said first threshold value, and the execution times of said plurality of second jobs corresponding to a plurality of third execution times and a plurality of fourth execution times;
said timer counting a second idle time, which is the sum of said first idle time and one of said plurality of first execution times, the sum of said first idle time and one of said plurality of second execution times, the sum of said first idle time and one of said plurality of third execution times, or the sum of said first idle time and one of said plurality of fourth execution times; and
said scheduler allocating one of said plurality of first jobs to said processor when said second idle time is smaller than said first threshold value and one of said plurality of second jobs to said processor when said second idle time is greater than said first threshold value.

12. The method for scheduling jobs with idle resources of claim 11, wherein said plurality of first execution times may be identical to said plurality of second execution times.

13. The method for scheduling jobs with idle resources of claim 11, wherein said plurality of third execution times may be identical to said plurality of fourth execution times.

14. The method for scheduling jobs with idle resources of claim 11, where in said step of when said second idle time is smaller than said first threshold value, said first threshold value is lowered to a second threshold value when the coefficient of the consumption rate of said plurality of second jobs versus the average consumption rate of said plurality of first jobs and said plurality of second jobs is negative.

15. The method for scheduling jobs with idle resources of claim 14, wherein the method for calculating said second threshold value or said third threshold value comprises the following steps of:
calculating an average consumption rate and the consumption rate of said plurality of second jobs;
calculating a logarithm value, which is the logarithm of the ratio of said consumption rate of said plurality of second jobs to said average consumption rate;
calculating a floating value, which is one of said plurality of third execution times of said plurality of second jobs multiplied by said logarithm value and a displacement value or one of said plurality of fourth execution times of said plurality of second jobs multiplied by said logarithm value and said displacement value; and
adding said floating value to said first threshold value.

16. The method for scheduling jobs with idle resources of claim 15, wherein said displacement value is used for adjusting the variation rate of said second threshold value or said third threshold value.

17. The method for scheduling jobs with idle resources of claim 11, where in said step of when said second idle time is greater than said first threshold value, said first threshold value is raised to a third threshold value when the coefficient of said consumption rate of said plurality of second jobs versus said average consumption rate of said plurality of first jobs and said plurality of second jobs is positive.

18. The method for scheduling jobs with idle resources of claim 17, wherein the method for calculating said second threshold value or said third threshold value comprises the following steps of:
calculating an average consumption rate and the consumption rate of said plurality of second jobs;
calculating a logarithm value, which is the logarithm of the ratio of said consumption rate of said plurality of second jobs to said average consumption rate;
calculating a floating value, which is one of said plurality of third execution times of said plurality of second jobs multiplied by said logarithm value and a displacement value or one of said plurality of fourth execution times of said plurality of second jobs multiplied by said logarithm value and said displacement value; and
adding said floating value to said first threshold value.

19. The method for scheduling jobs with idle resources of claim 18, wherein said displacement value is used for adjusting the variation rate of said second threshold value or said third threshold value.

20. A method for scheduling jobs with idle resources, comprising steps of:
a scheduler allocating a first job to a processor when said processor is idle, and the execution time of said first job corresponding to a first execution time;
a timer counting an idle time by accumulating said first execution time;
said scheduler allocating a second job to said processor when said idle time is smaller than a threshold value and a third job to said processor when said idle time is greater than said threshold value.

21. The method for scheduling jobs with idle resources of claim 20, wherein the execution time of said second job is a second execution time.

22. The method for scheduling jobs with idle resources of claim 21, wherein said second execution time may be identical to said first execution time.

23. The method for scheduling jobs with idle resources of claim 20, wherein the execution time of said third job is a third execution time.

24. A method for scheduling jobs with idle resources, comprising steps of:
a timer counting a first idle time when a processor is idle;
a scheduler allocating a first job to said processor when said first idle time is smaller than a threshold value, and the execution time of said first job corresponding to a first execution time, or said scheduler allocating a second job to said processor when said first idle time is greater than said threshold value, and the execution time of said second job corresponding to a second execution time;
said timer counting a second idle time, which is the sum of said first idle time and said first execution time or the sum of said first idle time and said second execution time; and
said scheduler allocating a third job to said processor when said second idle time is smaller than said threshold value and a fourth job to said processor when said second idle time is greater than said threshold value.

25. The method for scheduling jobs with idle resources of claim 24, wherein the execution time of the third job is a third execution time.

26. The method for scheduling jobs with idle resources of claim 25, wherein said third execution time may be identical to said first execution time.

27. The method for scheduling jobs with idle resources of claim 24, wherein the execution time of said fourth job is a fourth execution time.

28. The method for scheduling jobs with idle resources of claim 27, wherein said fourth execution time may be identical to said second execution time.

29. A method for scheduling jobs with idle resources, comprising steps of:
a scheduler allocating a first job to a processor when said processor is idle, and the execution time of said first job being a first execution time; and
said scheduler allocating a second job to said processor, and the execution time of said second job being a second execution time, and said first execution time is shorter than said second execution time.
